(19) United States
(12) Patent Application Publication
(10) Pub. No.: US 2025/0170760 A1
(43) Pub. Date: May 29, 2025

(54) SYSTEMS AND METHODS FOR RECYCLING WET WASTE MATERIALS

(71) Applicant: Batech Corporation, Roanoke, VA (US)

(72) Inventor: Boonlert Thepsimaung, Troutville, VA (US)

(21) Appl. No.: 18/711,486

(22) PCT Filed: Nov. 18, 2022
(86) PCT No.: PCT/US2022/050471

§ 371 Date: May 17, 2024

Related U.S. Application Data
(60) Provisional application No. 63/280,973, filed on Nov. 18, 2021.

(51) Int. Cl. B29B 17/00; B29B 17/04; B29C 48/395; B29C 48/76

(52) U.S. Cl. CPC B29B 17/0026; B29B 17/04; B29C 48/397; B29C 48/761; B29C 48/766; B29B 2017/0476

(57) ABSTRACT

Systems and methods for recycling wet wipe, or wet plastic comprising, products are provided. The recycling process can include processing broken-down wet waste material into a molten polymer using a dewatering, degassing, and compacting extruder. The recycling process can also include dewatering, degassing, and compacting the broken-down wet waste material and the molten polymer being processed in the dewatering, degassing, and compacting extruder and removing gas and waste material residue from the dewatering, degassing, and compacting extruder and capturing large residue particles.

### RELATED APPLICATION

The present application and presently disclosed subject matter claims the benefit of U.S. Provisional Patent Application Ser. No. 63/280,973, filed Nov. 18, 2021, the disclosure of which is incorporated herein by reference in its entirety.

### TECHNICAL FIELD

The present subject matter relates to systems and methods for recycling wet waste material. In particular, the present subject matter relates to systems and related methods for taking wet waste material, such as wet wipe fabrics and wet plastic waste, and process the waste material through a recycling process line that comprises recycling process machinery designed for converting wet waste material, such as wet wipe fabrics into recycled plastic.

### BACKGROUND

Wet wipe products have been available for use in a variety of products that can include baby wipes, hand wipes, make-up wipes, kitchen wipes, medical wipes, anti-bacterial or cleaning wipes, other wipes, or the like. A single manufacturer of wet wipe products can generate roughly three to five hundred tons of post-industrial waste per month. Currently, this waste is disposed of in landfills and incinerators. Post-consumer wet wipe waste is substantially larger in volume in comparison to post-industrial waste. Additionally, post-consumer wet wipe waste is significantly more challenging to recycle compared to post-industrial waste. Post-consumer waste has varying concerns regarding contamination levels and the collection of wipes. Due to this reason, a vast majority of post-consumer wet wipe waste ends up in landfills.

Generally, wet wipe products are normally made of nonwoven fabric. Roughly 90% of nonwoven fabrics being produced contain plastics or polymers, in particular, in the form of extruded polymer fibers that are bound in a manner that forms the nonwoven fabric. For example, these nonwoven fabrics can comprise spunbond nonwovens, spunlaced nonwovens, meltblown nonwovens, flashspun nonwovens, needlepunched nonwovens, other staple and/or continuous fiber nonwovens held together with different bonding materials, techniques, and methods, or the like. Approximately 10% and less are produced with biodegradable material techniques. Wet wipe fabrics can be made of polymer filaments bonded with natural fibers. For example, in some embodiments, the polymer content can range from 15% to 75%, containing polypropylene (PP) or polyethylene terephthalate (PET). Other polymers may also be used but on a less frequent basis. The fiber content can also contain natural fibers such as rayon, wood pulp, cotton, and other natural fibers, ranging from 15% to 75% depending on manufacturing design formulas.

Wet wipes are designed to absorb and preserve high levels of moisture (lotions) contents. Design load levels can range from 1% to 700% (by substrate weight) depending on the manufacturing design for their wet wipe product application. The moisture content in wet wipe fabric is considered as internal moisture content instead of surface moisture content.

Due to the high load levels of moisture content, wet wipes have been a challenge to recycle using traditional methods. The moisture in wet wipes in many instances can cause harm and can damage traditional recycling process. Further, traditional recycling methods and processes cannot effectively handle the moisture content of the wet wipes in a manner that can produce a reusable or processable product. Wet wipe fabrics can contain moisture or lotions that are beneficial for their initial intended use. For example, the ingredients of the lotion may contain antibacterial agents, perfume, Citric Acid, PEG-40 Hydrogenated Castor Oil, Sodium Citrate, Sorbitan Caprylate, Sodium Benzoate, Disodium EDTA, Bis-PEG/PPG-16/16, PEG/PPG-16/16, Dimethicone, Xanthan Gum, Pentadecalactone, Dipropylene Glycol, and Caprylic/Capric Triglyceride. Traditional recycling methods and processes, however, are not designed to effectively use, process, and/or remove these ingredients during the recycle process. Therefore, these wet wipes have been generally excluded from collection for traditional recycling methods and processes. For these reasons, there are currently not any recycling processes of post-industrial or post-consumer wet wipe waste.

As such, a need exists for providing recycling processes of post-industrial or post-consumer wet wipe waste that provide useful materials that can be reused in other applications.

### SUMMARY

The present subject matter relates to systems and methods for recycling wet waste material, such as wet wipe, or wet plastic comprising, products. In particular, the present subject matter relates to systems and related methods for taking wet waste material, such as wet wipe fabrics and/or wet plastic waste, and process the waste material through a recycling process line that comprises recycling process machinery designed for converting wet wipe fabric into recycled plastic.

While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a side plan view of an embodiment of a dewatering, degassing, and compacting extruder system that can be used in an embodiment of a wet wipe recycling system according to the present subject matter;

FIGS. 1A and 1B illustrate vertical cross-sectional side views of the embodiment of the dewatering, degassing, and compacting extruder system according to FIG. 1 that can be used in an embodiment of a wet wipe recycling system according to the present subject matter;

FIG. 1C illustrate vertical cross-sectional side views of the embodiment of the dewatering, degassing, and compacting extruder system according to FIG. 1 showing solid stage and molten stage degassing components that can be used in an embodiment of a wet wipe recycling system according to the present subject matter;

FIG. 2 illustrates a side plan view of an embodiment of screws used in the dewatering, degassing, and compacting extruder system according to FIG. 1 that can be used in an embodiment of a wet wipe recycling system according to the present subject matter;

FIG. 3 illustrates a side plan view of the embodiment of the dewatering, degassing, and compacting extruder system according to FIG. 1 with translucent walls to illustrate the placement of the screw according to FIG. 2 within an embodiment of an extruder barrel according to the present subject matter;

FIG. 3A illustrates a vertical cross-sectional side view of a portion of the embodiment of the dewatering, degassing, and compacting extruder system according to FIG. 1 showing an embodiment of a bearing and die housing and adapter where a discharging screw connects to a main screw according to the present subject matter;

FIG. 4 illustrates a schematic side plan view of an embodiment of a liquid ring type vacuum pump system used in an embodiment of a wet wipe recycling system according to the present subject matter;

FIGS. 5A-5D illustrate schematic side plan views of embodiments of wet wipe waste recycling systems used to produce wet wipe plastic composite products or pellets according to the present subject matter; and

FIGS. 6A-6D illustrate schematic side plan views of embodiments of wet wipe waste recycling system used to produce hard-shell lightweight plastic pellets according to the present subject matter;

FIG. 7 illustrates a simple flowchart showing input material and output material of an embodiment of a wet wipe waste recycling process according to the present subject matter;

FIG. 8 illustrates a simple flowchart showing output material of an embodiment of a wet wipe waste recycling process used to form recycled products and good according to the present subject matter;

FIG. 9 illustrates an embodiment of another output material of an embodiment of a wet wipe waste recycling process according to the present subject matter; and

FIG. 10 illustrates a simple flowchart showing input material of hydrapulper/hydro pulp plastics waste and output material and products of an embodiment of a wet plastic recycling process according to the present subject matter.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only and is not intended as limiting the broader aspects of the present subject matter, which broader aspects are embodied in exemplary constructions.

Although the terms first, second, right, left, front, back, top, bottom, etc. may be used herein to describe various features, elements, components, regions, layers and/or sections, these features, elements, components, regions, layers and/or sections should not be limited by these terms. These terms are only used to distinguish one feature, element, component, region, layer, or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

The term “plastic” or “thermoplastic” is used herein to mean any material formed from a polymer which softens and flows when heated; such a polymer may be heated and softened a number of times without suffering any basic alteration in characteristics, provided heating is below the decomposition temperature of the polymer. Examples of thermoplastic polymers include, by way of illustration only, polyolefins, polyesters, polyamides, polyurethanes, acrylic ester polymers and copolymers, polyvinyl chloride, polyvinyl acetate, etc. and copolymers thereof.

As used herein, the term “wet waste material” includes wet wipe products, such as wet woven and non-woven fabrics with or without polymers, and wet plastic waste material, such as hydrapulper/hydro pulp waste, wet plastic films, wet shredded plastics, and wet waste comprising natural or synthetic rubber.

The present subject matter relates to systems, apparatuses, and methods for recycling wet waste materials, such as wet wipe fabrics. The waste wet wipes material can be sent through custom-designed recycling wet wipes machinery. The systems and apparatuses can convert waste wet wipes into pellet form. The recycled wet wipe (pellet form) can be suitable for many applications in the plastics industry.

The systems, apparatuses, and methods disclosure herein can provide a way to recycle wet wipes and wet plastic waste, and convert them to wet wipe plastic composite (WWPC). There exists a potential for using WWPC to substitute wood plastic composite (WPC). Wood plastic composites (WPC) materials are widely used in the plastics industry, including extrusion profile applications decking lumber, decking rails, fencing, door & window components. WPCs are also used in plastics injection molding and other forms of molding applications. Products made of WPC are durable and require low maintenance. The lifespan of products made of WPC is two to three times longer compared to products made from natural wood. WPC materials require roughly 50:50 mixtures of thermoplastic polymers and wood particles (wood flour or wood fiber). Wood flour or wood fiber must be dry before the raw material can be used in the WPC manufacturing process. Common plastics used in WPC are polypropylene (PP), polystyrene (PS), polyvinyl chloride (PVC), and polyethylene (PE, LDPE, and HDPE). Recycled polymers are also often used in the WPC process. The fibers used in WPC have particle sizes ranging from 177 microns to 2000 microns. The selection of fiber specifications depends on product quality requirements. The process of compounding wood fiber with plastic requires a twin-screw extruder and an aggressive screw mixer design configuration. The WPC manufacturing process requires additives such as waxes, coupling agents, pigments, and others. These additives help the process of mixing, bonding/adhesion, and product surface appearance. Adding wood fiber to the polymer improves the flexural modulus properties while reducing the percentage of polymers that help in reducing cost.

The process of compounding WWPC is more straightforward compared to the WPC process. Wet wipe fabrics contain natural fibers with a uniform distribution particle size that are generally smaller than wood flour and wood fiber. Wet wipes are made of fibers and polymers that are already bonded in fabric form, and the input fibers have a smaller particle size. The WWPC process can be achieved using a single screw extruder. The twin-screw extruder may also be used in the WWPC process but is unnecessary. The moisture in wet wipes does not entirely harm the recycling process. Wet wipe fabrics contain good moisture or lotions (the ingredients of the lotion may contain antibacterial agents, perfume, Citric Acid, PEG-40 Hydrogenated Castor Oil, Sodium Citrate, Sorbitan Caprylate, Sodium Benzoate, Disodium EDTA, Bis-PEG/PPG-16/16, PEG/PPG-16/16, Dimethicone, Xanthan Gum, Pentadecalactone, Dipropylene Glycol, and Caprylic/Capric Triglyceride). Many of these ingredients can help the WWPC manufacturing process to improve throughput, material-dispersion/mixing, bonding, and product surface appearance. The operation costs of manufacturing WWPC can be significantly less compared to the WPC manufacturing process. The WWPC manufacturing process uses recycled wet wipe fabrics containing fiber and plastic compared to the WPC manufacturing process, which requires the input of various raw materials.

There are a number of benefits of WWPC as compared to WPC. For example, WWPC can have low manufacturing costs due to the source of raw materials. The process of compounding WWPC can also be more straightforward because of the wet wipe fabrics' consistent layers of fiber and polymer and their small size fiber particles. WWPC can have a higher water-resistance in comparison to WPC. The lower water-resistance of WPC can lead to higher moisture absorption, which, in turn, can lead to a higher susceptibility to mold and decay. WWPC can be made of recycled material (fiber and polymer), which is more sustainable and environmentally friendly.

The systems, apparatuses, and methods disclosure herein can remove moisture content in wet wipe waste in a controlled manner that allows for wet wipe recycling.

The recycled input raw material (wet wipes) can generally be received in bale form from a post-industrial provider. Wet wipes contained in the same bale can have different levels of moisture content. It is estimated that the top portion of the bale can contain a moisture content of 20-100% by substrate weight. The middle portion of the bale may contain a moisture content of 100-200% by substrate weight, and the bottom can contain a moisture content of 200%-500% or more by substrate weight. Tests have been performed to remove moisture content in wet wipe fabrics using machinery such as film densifier machines, tumbler dryers, pellet mills or press mills. The film densifier machine, which is also known as a plastic agglomerate machine, and other similar machines like the cutter compactor can be used to cut up or chop film into smaller particles. For example, such machines use a high-speed rotating blade or knife to chop film particles into small pieces. At the same time, the rotating blade/knife can generate heat through friction from the high rotation speed. The heat friction helps the film dry (if the film contains moisture) and can shrink the film in size simultaneously. Due to the high moisture content in the wet wipes, these machines did not effectively process the wet wipes alone. The high moisture content of the wet wipes prevented the heat friction from building up to a high enough temperature to dry or shrink wet wipe fabric.

Tumbler dryers are dryers in which material flows through a large, rotating, horizontal screen drum. During this process, heated air is circulated through the drum of the dryer to dry the material. Again, due to the high moisture content in the wet wipes, these dryers did not effectively process the wet wipes alone. The heated air was not sufficient to evaporate moisture contents to achieve satisfactory dryness of material. Other concerns during the testing of these dryers included dust particles from wet wipe fabrics contaminating the air heating system.

Pellet mills or press mills use rotating rollers on the die surface. The rollers mill and compress the material through the die holes. The heat created by friction from the rollers rotating at high rotation speeds against the material softens and compacts the material. Once again, due to the high moisture content in the wet wipes, these pellet mills or press mills did not effectively process the wet wipes alone. During the tests, the moisture content prevented the heat friction from building up and caused the die holes to freeze and the rollers to seize.

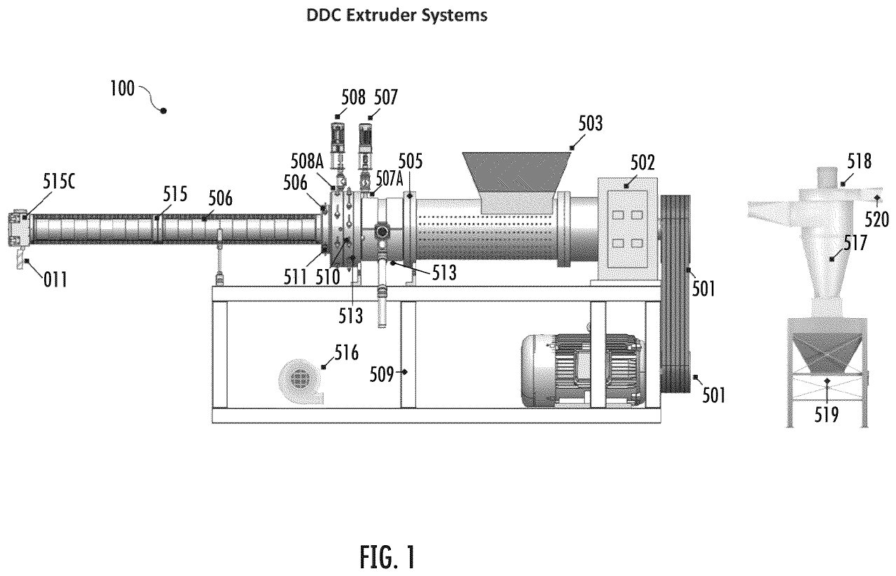

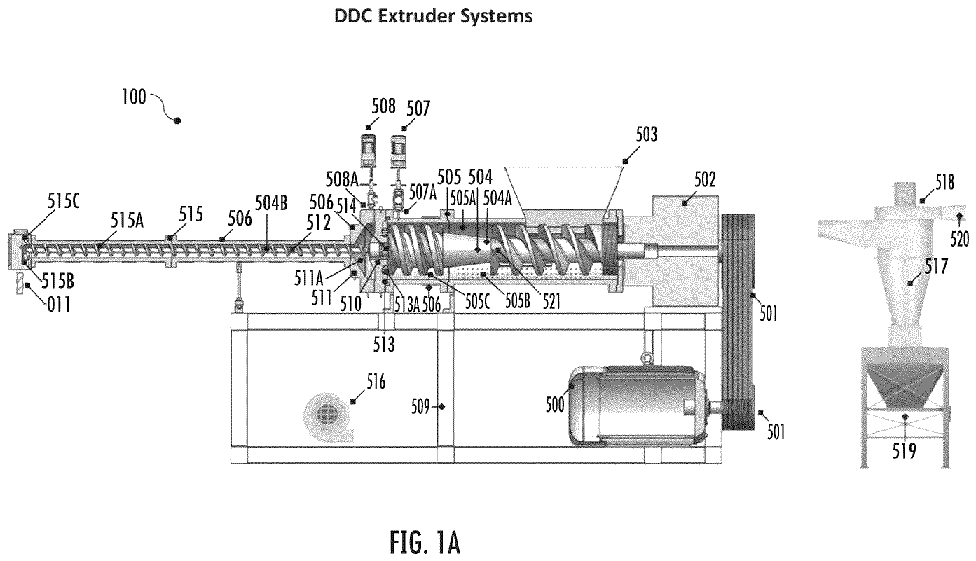

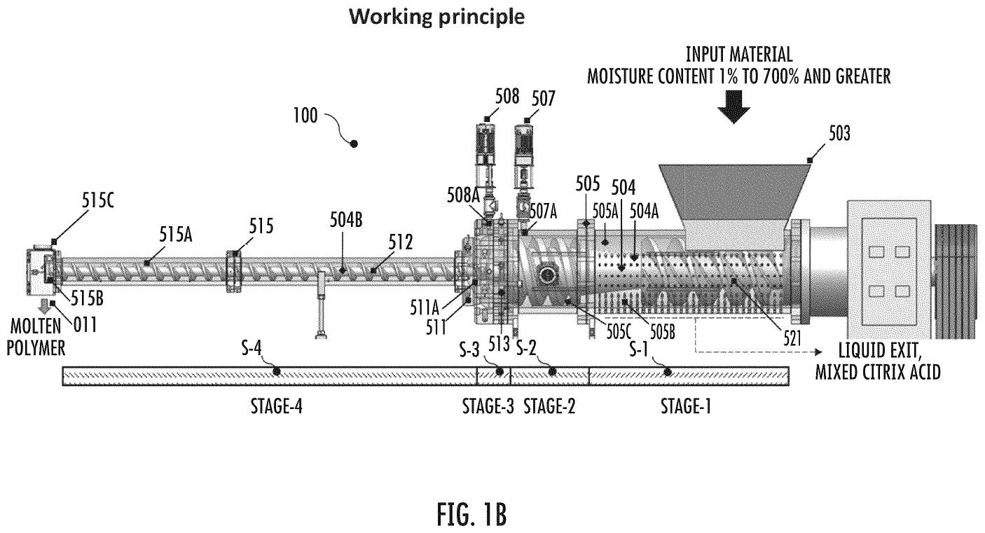

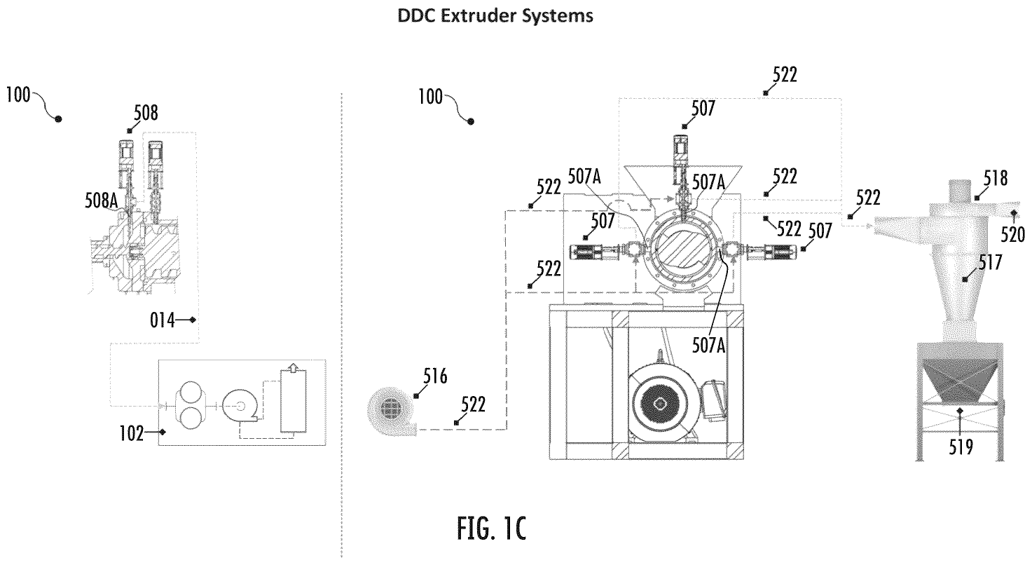

Referring to FIGS. 1-3A, in order to remove wet wipe fabric internal moisture content from the wet wipe waste, a dewatering, degassing, and compacting (DDC) extruder system, generally designated 100, is provided to remove liquid and gas from the waste wet wipe being processed and compact the waste into molten polymer. Thus, the DDC extruder system 100 performs three primary functions of dewatering, degassing, and compacting the waste. With special dewatering and degassing structures in the DDC extruder system 100, the extruder system 100 is capable of removing internal moisture contents in waste wet wipe fabrics. In the same process, the DDC extruder system 100 compacts lightweight fabric into molten polymer before being discharged from the DDC extruder. The molten polymer stage increases the density of the material, providing a better throughput to the process. While described in conjunction with processing and recycling wet wipe material, the DDC extruder system described herein can be use with other applications such as non-woven fabrics, hydro pulp plastics, wet plastic film, plastic film, and wet flake plastics. In particular, the DDC extruder system, as disclosed herein, can be used in recycling materials containing high internal moisture content and or high surface moisture content,

The DDC Extruder system 100 can comprise a motor 500, pulley/belts 501 and a gear box 502 used to control rotation of the specially designed extruder screw 504 as shown in FIGS. 1 and 1A. The DDC Extruder system 100 can comprise a hopper 503 for feeding the system 100, a main barrel 505 with heaters 506 on the barrel 505, bearing housing 510, adapter 511, and barrel 515 as shown in FIGS. 1, 1A, and 1B. The main barrel 505 can comprise an inner chamber 505A having a compressing and dewatering section 505B and a heating, degassing, and compacting section 505C following the compressing and dewatering section 505B. The extruder screw 504 can comprise a dewatering, degassing and compression screw section 504A and a discharge screw section 504B. The dewatering, degassing and compression screw section 504A of the extruder screw 504 can be configured to rotate within the inner chamber 505A of the main barrel 505. In some embodiments, the extruder screw 504 can be a unitary screw. In some embodiments as shown, the dewatering, degassing and compression screw section 504A of the extruder screw 504 can comprise a main extruder screw 521 and the discharging screw section 504B can comprise a discharge extruder screw 512 connected to the main extruder screw 521.

The rotation of dewatering, degassing and compression screw section 504A of the extruder screw 504 within the inner chamber 505A can facilitate the removal of liquid from the wet waste material being processed, the compression of the wet waste material, and the melting and degassing of the wet waste material as the heaters 506 heat the main barrel 505. A die 513 can be positioned at the end of the main barrel 505. The die 513 can comprise one or more flow channels 513A and configured to restrict a flow of material being processed in the main barrel 505. The die 513 with the small flow channels 513A can create backpressure and heat friction to help melt the wet waste material being processed into the molten polymer. Molten polymer material that exits through the die 513 can enter a predischarge flow channel 511A which is configured for receiving the molten polymer exiting the die. The predischarge flow channel 511A is heated to aid further with the heating and degassing the molten polymer. A discharge barrel 515 can be connected to the predischarge flow channel 511A. The discharge barrel 515 can comprise an inner chamber 515A in which the discharge screw section 504B of the extruder screw 504 resides for receiving the molten polymer and a discharge port 515B for discharging the molten polymer. A hood 515C with a vacuum line (not shown) attached to it can cover a portion of the discharge port 515B to remove additional gas and vapors as the molten polymer 011 exits the discharge port 515B.

To facilitate the turning of the wet waste material to a molten polymer, gas, vapors, and/or material residue should be removed from the extruder system 100 to increase the speed and opportunity for the wet waste material to remove the wetness and the polymers therein to melt. For this reason, one or more degassing ports 507A are provided on the main barrel 505 to remove gas or vapor released by a molten polymer generated from a waste material being processed within the main barrel 505. These one or more degassing ports 507A can be considered solid stage degassing ports. Additionally, one or more degassing ports 508A can provided that engage the predischarge flow channel 511A to remove gas or vapor released by a molten polymer that has entered the predischarge flow channel 511A from the die 513. These one or more degassing ports 508A can be considered molten stage degassing ports. Additionally, in some embodiments, to facilitate the turning of the wet waste material into a molten polymer, polymer resin can be added to the extruder system 100. In some embodiments, extra polymer can be added as described below, for example, if the wet waste material, such as certain wet wipe products have a lower polymer content.

Referring to FIGS. 1, 1A, 1B, and 1C, the input wet waste material is fed into the DDC extruder hopper 503, then the dewatering, degassing and compression screw section 504A of the extruder screw 504 conveys the material to compress and dewater the material in a first stage S1 in the screened portion of the barrel 505. At a second stage S2 in a portion of the barrel 505 on which the heaters 506 resides, the material is heated and conveyed to the die. The material is compressed and milled between the die and kneading paddles of the dewatering, degassing and compression screw section 504A of the extruder screw 504 into a molten polymer. The materials are first degassed using the one or more degassing ports 507A located in the main barrel 505. For example, the one or more degassing ports 507A can be located in the heating, degassing, and compacting section 505C of the main barrel 505.

Each of the one or more solid stage degassing ports 507A can have a corresponding solid stage vent stuffer 507 that can be configured to prevent backflow of material out of the degassing port 507A. FIG. 1C illustrates three solid stage degassing ports 507A and three solid stage vent stuffer 507 that engage the three solid stage degassing ports 507A. As shown in FIG. 1C, each of the solid stage vent stuffers 507 can have a vapor exhaust line 522 extending therefrom. The respective solid stage vent stuffer 507 can be configured to prevent waste material being processed from entering the vapor exhaust line 522. A transfer blower 516 can be provided and can be connected to the vapor exhaust lines 522 of the respective solid stage vent stuffers 507. The transfer blower 516 can be configured to provide air through the vapor exhaust lines 522 to convey vapors and residue material particles through the vapor exhaust lines 522 should any material particles pass through the respective solid stage vent stuffer 507. A cyclone system 517 can be connected to the vapor exhaust line 522. The cyclone system 517 can be configured to separate the material particles from the vapors provided to the cyclone system 517 by the respective vapor exhaust lines 522. Thereby, the vent stuffer transfer blower 516 conveys materials and gases that may pass through the solid stage vent stuffer 507 to cyclone system 517 therein separating solid materials to a cyclone system discharge port 519. The collected solid materials can be reintroduced in the extruder system 100 at some point or can be disposed of in another fashion. The cyclone system 517 can comprise cyclone system transfer blower 518 boosts air velocity to transport gases through exhaust port 520. The removal of the gas, vapors, and residue through the solid stage degassing ports 507A can increase the effectiveness of the extruder system 100 of achieving a molten polymer from wet waste material with a high fluid or moisture content, such as wet wipe waste material.

At a third stage S3 as shown in FIG. 1B, in a portion of the barrel 505, the materials are discharged from the die 513 into the predischarge flow channel 511A that can be defined within an adapter 511 attached to the barrel 515. The molten polymer material can be degassed using the one or more molten stage degassing ports 508A that can be in fluid communicate with the predischarge flow channel 511A. For example, the one or more molten stage degassing ports 508A can be located in the adapter 511 that can aid in defining the predischarge flow channel 511A.

Each of the one or more molten stage degassing ports 508A can have a corresponding molten stage vent stuffer 508 that can be configured to prevent backflow of material out of the degassing port 508A. As shown in FIG. 1C, each of the one or more molten stage vent stuffers 508 can be connected to the molten stage degassing port 508A and connected to a vacuum line 014. The respective molten stage vent stuffer 508 can be configured to prevent the molten polymer within the predischarge flow channel 511 from entering the vacuum line 014 and allow only gas or vapors to enter the vacuum line 014 that connects to the degassing system 102. As above, the removal of the gas, vapors, and residue through the molten stage degassing ports 508A can also increase the effectiveness of the extruder system 100 of achieving a molten polymer from wet waste material with a high fluid or moisture content, such as wet wipe waste material.

The solid stage vent stuffer 507 and the molten stage vent stuffer 508 can be similar in construction. Each vent stuffer 507, 508 can comprise a motor, a support frame, a shaft coupling, a barrel, a screw, gas/vapor entry port, and gas/vapor exit port with the motor being linked to the screw via shaft coupling as explained further below. The screw of the respective vent stuffer 507, 508 can rotate in a direction within the barrel to prevent material from entering the respective vent stuffer gas/vapor entry port, while gas or vapors are permitted to flow out of the gas/vapor exit port.

At a fourth stage S4, which is in the discharging barrel 515, the material is conveyed and discharged by the discharging screw section 504B of the extruder screw 504, i.e., the discharge screw 512, from the DDC extruder system 100. the discharging barrel 515 can be heated by heaters 506 to facilitate further processing of the molten polymer as it is conveyed by the discharge screw 512.

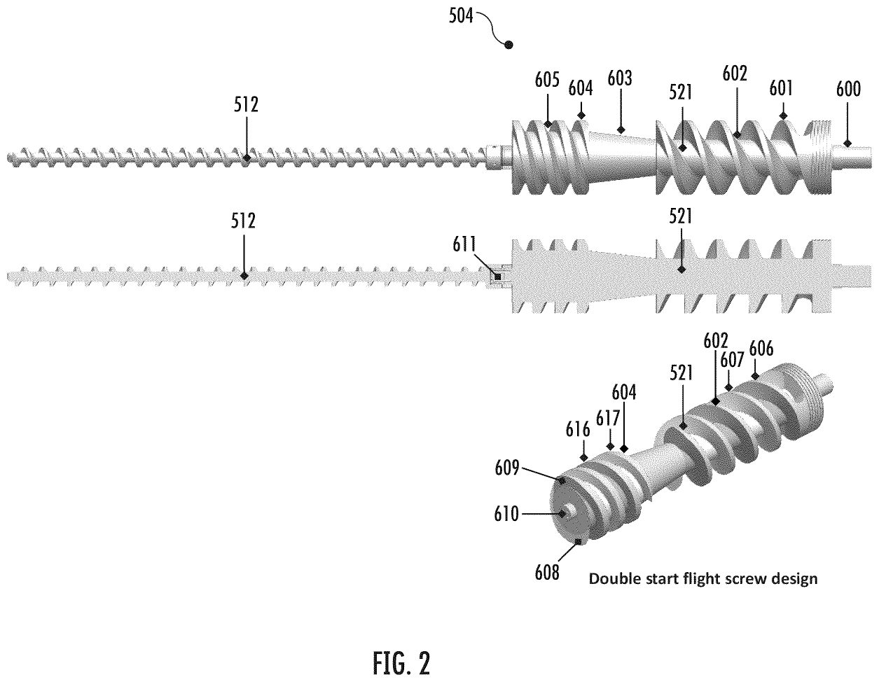

The extruder screw 504 will be described as two connected screws 521 and 512 below. The main extruder screw 521 and the discharge screw 512 of the extruder screw 504 illustrated in FIGS. 1A and 1B is shown in more detail in FIG. 2. The screw 521 can comprise a shaft 600 for attachment of the gearbox 502 for rotating the screw 521 in the barrel 505 and the discharge screw 512 in barrel 515. The electric motor 500 and pulleys 501 drive the gearbox 502. The screw 521 can include a first stage (Stage-1) that comprises a dewatering zone. In particular, the screw 521 can comprise a long screw pitch 601 with a double start flight with a first flight 606 and a second flight 607 and deep screw flight channels 602 that forms a section of the dewatering zone. This section is specifically designed to be used to convey wet wipe fabrics, which are a low density, lightweight material. The screw 504 can also comprise a section 603 that is tapered and has no screw flight in a latter portion of the first stage that forms the dewatering zone. The design allows for material to be compressed for dewatering. The screw 521 can comprise a second stage (Stage-2) that forms a heating and mixing zone. In a first section of the second stage, the screw 521 can comprise a short screw pitch 604 with a double start flight with a first flight 606 and a second flight 607 and a shallow screw flight channel 605. This section of the screw 504 is designed to obtain a uniform flow and allows heat transfer from the barrel to the material. The screw 521 can also comprise a double start flight screw design with kneading paddles 608 and 609, the kneading paddles perform milling and mixing of the material on the die 513 to turn the material into a molten polymer. The screw 521 can also comprise a connector shaft 610. The connector shaft 610 can be coupled to a screw adapter 611 attaching the screw 521 to a discharge screw 512. The discharge screw 512 can comprise a short screw pitch 612 and a shallow screw flight channel 613. This section of the discharge screw 512 can be designed to obtain a uniform flow, allows heat transfer from the barrel to the material, and compacts the molten polymer before being discharged from a discharge port 515B.

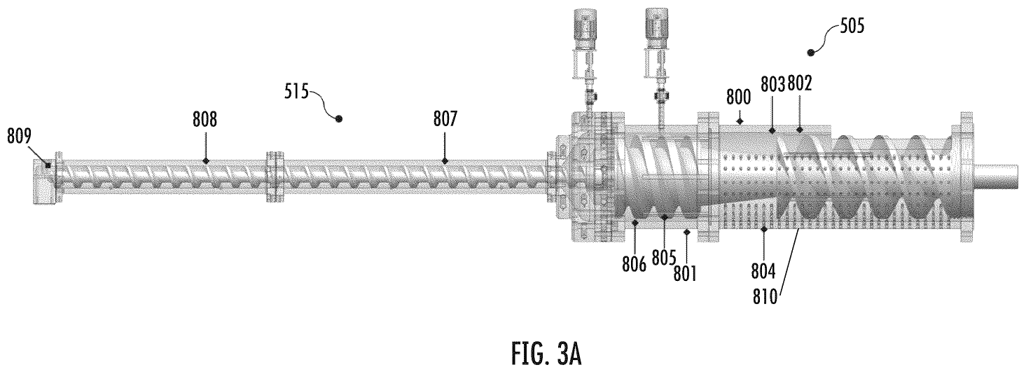

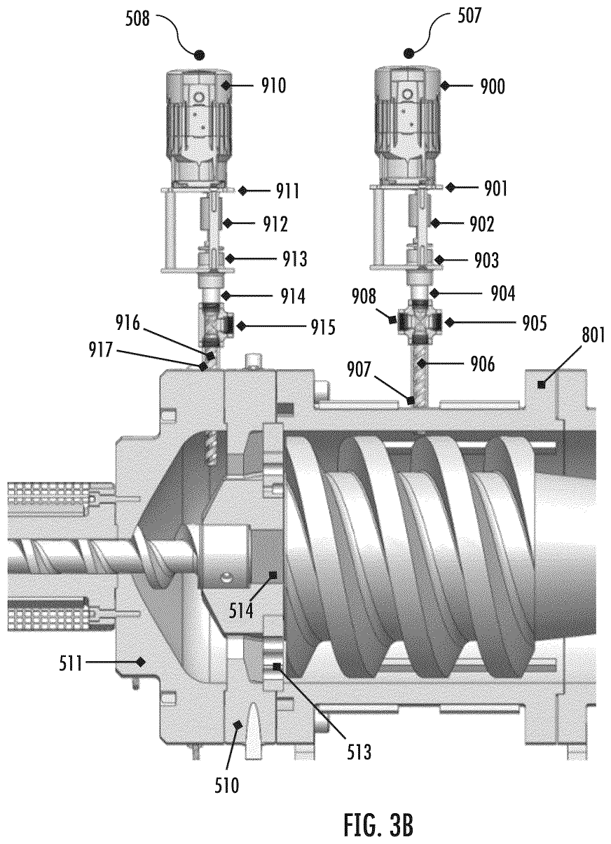

Referring to FIG. 3, the stages of the screw 521 and sections of the barrel 505 are shown. The barrel 505 can comprise a first barrel section 800 which is a dewatering barrel. The first barrel section 800 can comprise drain holes 804 which allow liquids, or mixed citric acid 810 to escape from the first barrel section 800 while the material is being compressed. The first barrel section 800 can comprise a breaker bar 802 that works as a flow-disrupting device that can prevent the material from binding at the barrel due to the outward force created from the screw's rotation. The barrel and screw tolerance 803 in this section of barrel 505 can allow for material backflow to prevent the material from being over-compressed and prevent drain holes 804 from being blocked. The barrel 505 can comprise a second barrel section 801, which can comprise a start for a first material heating zone with heaters 506. The second barrel section 801 can also comprise a breaker bar 805 that works as a flow-disrupting device that can prevent the material from binding at the barrel due to the outward force created from the screw's rotation. The barrel and screw tolerance 806 in this section of barrel 505 can also allow for material backflow to prevent the material from being over-compressed. The second barrel section 801 can also comprise a vent stuffer 507 shown in more detail in FIG. 3A. The second barrel element 801 can be attached to a bearing and die housing 510 shown in FIG. 3A. The bearing 514 and die 513 can be mounted on the bearing and die housing 510. The bearing 514 retains the rotating motion of the screw 521. The die 513 restricts the flow of material and, at the same time, creates backpressure and heat friction to help melt the material into a molten polymer. The bearing and die housing 510 can be attached to the adapter 511, the adapter 511 can comprise a vent stuffer 508 shown in more detail in FIG. 3A. The adapter 511 can be attached to barrel 515, the barrel 515 can comprise two barrels 807 and 808. Barrels 807 and 808 can provide a continuation of heating with heaters 506 (see FIGS. 1 and 1A) positioned around the barrels 807 and 808 to the material to produce zones for better mixing and compacting of the material before being discharged.

Referring to FIG. 3A, on the barrel 801, a vent stuffer 507 can comprise of a motor 900, a support frame 901, a shaft coupling 902, a packing seal 903, a barrel 904, material and gas vapor exit port 905, transfer inlet port 908 and a screw 906. The motor 900 is mounted on a support frame 901. The shaft coupling 902 is coupled between the shaft of motor 900, screw 906 and gas vapor entry port 907. The packing seal 903 prevents gas from escaping the DDC extruder system 100. The screw 906 is installed within barrel 904. The screw 906 speed rotation prevents material from escaping barrel 801. On the adapter 511, a vent stuffer 508 can comprise of a motor 910, a support frame 911, a shaft coupling 912, a packing seal 913, a barrel 914, gas vapor exist port 915, and a screw 916, gas vapor entry port 917. The motor 910 is mounted on a support frame 911. The shaft coupling 912 is coupled between the shaft of motor 910 and the screw 916. The packing seal 913 prevents gas from escaping the DDC extruder system 100. The screw 916 is installed within barrel 914. The screw 916 speed rotation prevents material from entering the degassing line while gases can be vacuumed through vent port 915. A bearing and die housing 510 can comprise a heater 506 for material heating zone two. Heating zone two helps material in the die 513 melt when the die is cold during the initial running of the DDC extruder system 100. Heating zone two also enables the temperature acceleration of the die 513 for improved mixing and melting of the material. An adapter 511 can comprise a heater 506 (see FIGS. 1 and 1a) for material heating zone three. Heating zone three allows the solid polymers within the adapter to be melted during the initial running of the DDC extruder system 100. An adapter 511 compresses and directs the polymer melt flow from the die 513 to discharge barrel 807 shown in FIG. 3.

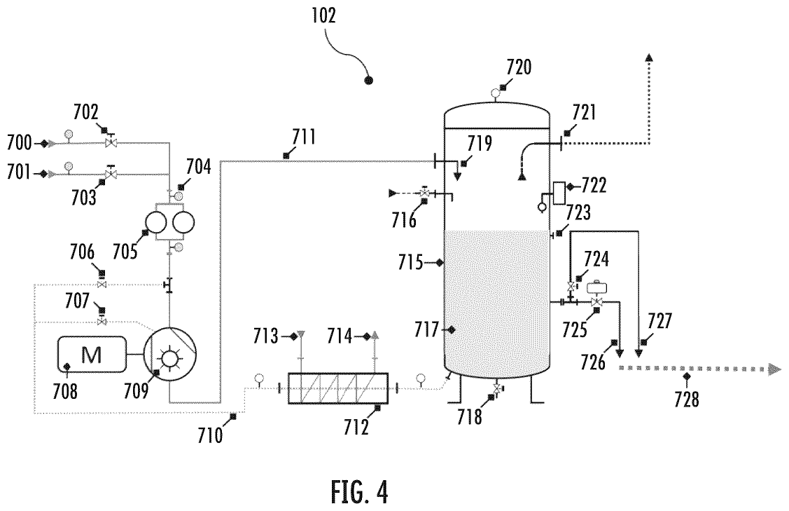

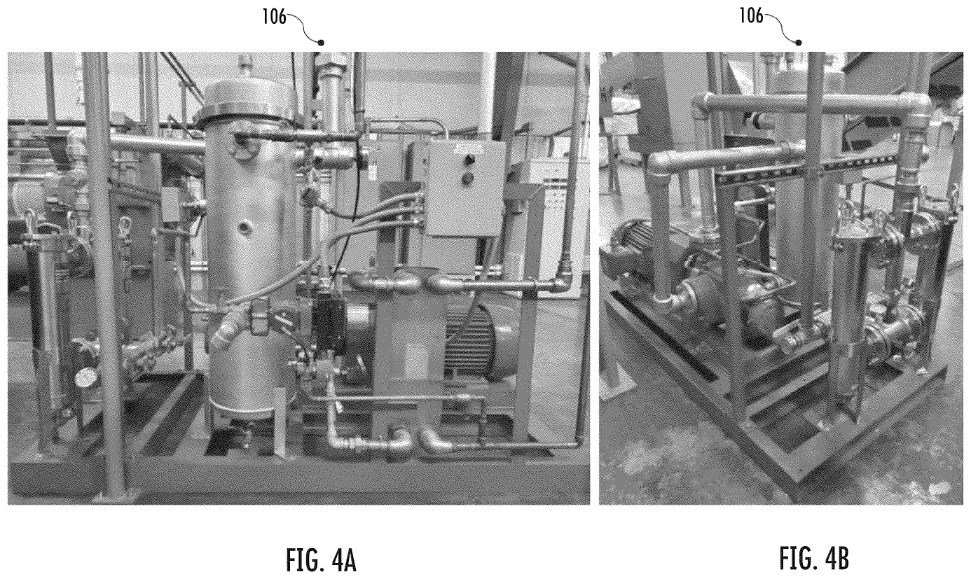

The DDC extruder system 100 can comprise a degassing system, which can include a vacuum pump. Referring to FIG. 4, the degassing system 102 can comprise a vapor inlet 700 for the DDC extruder system 100 and a vapor inlet 701 for a compound extruder with vapor control valve 702, 703, a vacuum gauge 704, trap systems 705 and liquid control valves 706, 707. The degassing system 102 can comprise a motor 708, a liquid ring type vacuum pump 709, process liquid line 710, liquid and gas discharge lines 711, heat exchanger 712, cooling water inlet 713, cooling water return 714, a separation tank 715, water fill and makeup 716, process liquid 717, drain value 718, separation tank inlet 719, pressure and temperature gauge 720, gas discharge port 721, level switch 722, level inspection sight glass 723, liquid level control valve 724, pneumatic liquid level safety valve 725, Discharge liquid level safety valve 726, discharge liquid overflow 727, liquids, mixed citric acid 728, along with other components shown in FIG. 4. The DDC extruding process can create a very high volume of vapor. Therefore, a vacuum pump system can be used to remove the gas. The vacuum pump can be a liquid ring type vacuum pump system. In some embodiments, water is the medium that is used in the liquid ring vacuum pump. The liquid ring vacuum pump can provide outstanding performance for at least several reasons. The liquid ring pump can be self-cleaning to minimize internal pump residue buildup. When hot vapor condensation is in the pump, the condensation is compatible with the medium used in the vacuum process. Thus, there will be no lubricant oil contamination problems like dry vacuum pumps. Bearings can be installed externally and lubricated with grease. The bearings have no contact point with steam or vapor. Thus, there will be no seized bearing issues or contamination of lubrication. The condensate from wet wipe can be used as seal liquid and cooling medium for liquid ring vacuum pump system.

FIGS. 4A and 4B show an embodiment of a liquid ring vacuum pump 106. The principles of operations for the degassing system 102 shown in FIG. 4 are to have the gas and residues (created from the DDC extruder and the compound extruder) to flow through the trap system. The trap system can capture large residue particles from the vapors before it enters the vacuum pump. After the vapors enter the vacuum pump, the vapors are compressed and condensed by liquid circulation. The liquid within the vacuum pump process is cooled by the heat exchanger via an external medium. Then the liquids and gas discharge from the vacuum pump into the separation tank. The separation tank separates liquids from gas, and the gases can be discharged from the separation tank through the discharge exhaust pipe. The separation tank can be designed to hold enough volume of liquid to recirculate the cooling loop within the pump. The separation tank can also be adapted with a high-level tank overflow safety valve. If the tank level reaches a normal overflow level, the liquid will run through the tank overflow to maintain tank levels. In some cases, if the liquid level continuously increases, such as if the overflow pipe is blocked or clogged, whenever the liquid level reaches a high level, the safety pneumatic valve will be opened.

The present disclosure can also provide a plastic foaming process that can create a cellular structure within molten plastic. The standard methods used in the plastic foaming process are to use direct-injected gas and chemical foaming agents. The direct-injected gas process uses gases such as nitrogen, carbon dioxide, pentane, or butane. The gas is injected directly into the extruder process under high pressure to mix with the polymers. The combination of gas and polymer creates a cellular structure or foaming polymer. The chemical foaming agent process can add a small percentage of special compound foaming agents (solid form) to the polymer melt. The foaming agent decomposes during the extrusion process and releases an expanding gas to create the foaming polymer. Plastic foaming has different properties. Thus, it is used in different application areas.

As disclosed herein, wet wipe fabrics (non-woven fabric) can comprise consistent layers of fiber and polymer, such as a thermoplastic polymer. The fiber can absorb and preserve internal moisture content. The DDC extruder system and related process as disclosed herein can utilize these fabric properties to permit the production of a hard-shell lightweight plastic (HSLP) pellet using H₂O gas as a nucleating agent. This technique can also be used in other processes, such as the profile extrusion process.

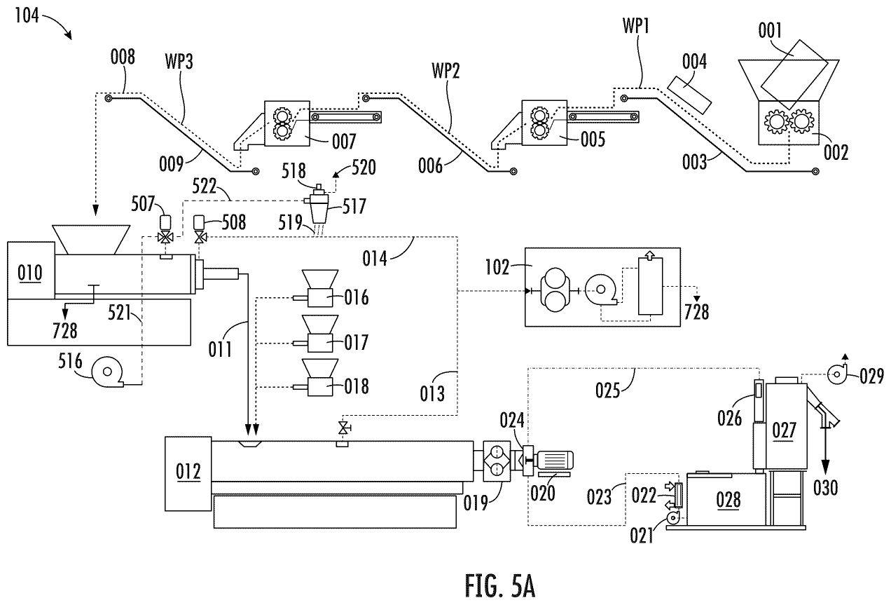

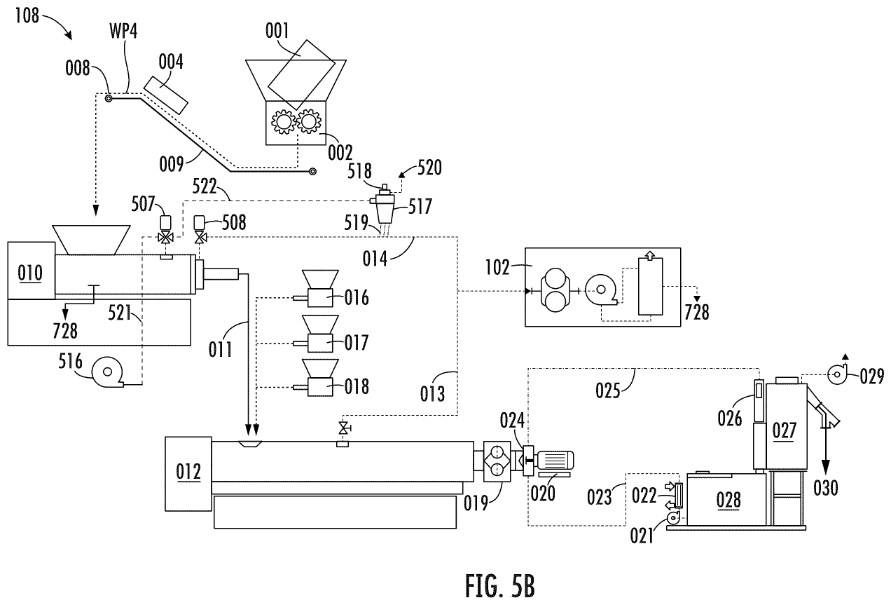

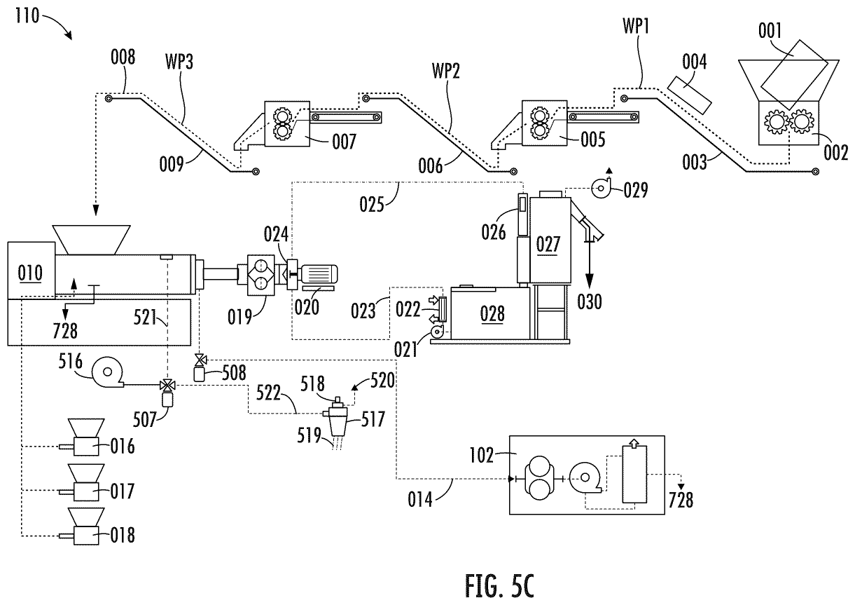

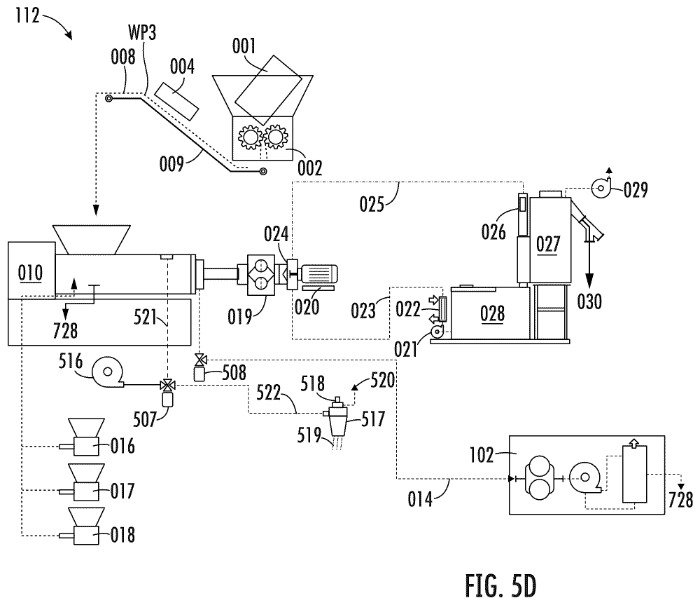

FIG. 5A illustrates an embodiment of a system and process for recycling wet wipes products, generally designated 104. The wet wipe waste can be provided in bales, for example, as baled industrial wet wipe waste. Each bale 001 can, for example, have a size that is approximately 60 inches×32 inches×32 inches. The bale 001 can be fed into a hopper of a first shredder 002 that can shred and breakdown the compressed wet wipe fabric (material) contained in the bale 001 into wet wipe waste pieces WP1 that are a more manageable size before being discharged in a consistent manner onto a first belt conveyor 003. As an example, in some embodiments, the wet wipe waste pieces WP1 can have a nominal size of roughly about 8 inches×4 inches×2 inches or smaller when the wet wipe waste pieces WP1 leave the first shredder 002. The first belt conveyor 003 can convey the wet wipe waste pieces WP1 through a metal detector system 004. If there is any metal detected, the system 004 will stop wet wipe recycling system 104 and sound an alarm. The first belt conveyor 003 can feed material into a second shredder 005. The second shredder 005 can shred and breakdown the wet wipe waste pieces WP1 from the first shredder 002 into wet wipe waste pieces WP2 of a smaller size before being discharged in a consistent manner onto a second belt conveyor 006. The wet wipe waste pieces WP2 is of a smaller size than the wet wipe waste pieces WP1. For example, in some embodiments, the wet wipe waste pieces WP2 can have a nominal size of roughly about 8 inches×1 inch×0.5 inches.

The second belt conveyor 006 conveys wet wipe waste pieces WP2 to the third shredder 007 where the third shredder 007 can shred and breakdown the wet wipe waste pieces WP2 from the second shredder 005 into wet wipe waste pieces WP3 of even smaller size. For example, in some embodiments, the wet wipe waste pieces WP3 can have a nominal size of roughly about 1 inch×0.5 inches×0.5 inches. Thus, generally speaking, the wet wipe waste pieces WP3 is a size 008 conducive for being fed to a DDC extruder system 010 as described above. The shredders can be single shaft, dual shaft, triple shaft, or quad shaft.

The wet wipe waste pieces WP3 can then be discharged from third shredder 007 onto a third belt conveyor 009 which can then convey the wet wipe waste pieces WP3 to the DDC extruder system 010. The DDC extruder system 010 can then process the wet wipe waste pieces WP3 by compressing to dewater and/or remove liquids, mixed citric acid 728, vent stuffers 507 and 508 degasses and compacting the wet wipe waste material to a molten polymer. The transfer blower 516 conveys materials and gases that may pass through the vent stuffer 507 to the cyclone system 517. The cyclone system 517 separates solid materials to discharge port 519, the transfer blower 518 boosts air velocity to transport gases/vapors through exhaust port 520. The DDC extruder system 010 can discharge the molten polymer 011 into a compound extruder system 012 for further processing. While the molten polymer 011 is discharging, any remaining gas in the molten polymer is allowed to escape into the atmosphere before entering the compound extruder system 012. At this point in the processing system 104, feeders 016, 017, and 018 can feed additives, colors, and booster resin into the compound extruder system 012 as needed or desired for the end recycled product based on a formula requirement.

The compound extruder system 012 can finish the processes in two stages. In the first zone of the compound extruder system 012, the compound extruder system 012 can continuously mix the molten polymer which includes fibers and polymer simultaneously with the additives, colors, and booster resin. In the second stage of the compound extruder system 012, the compound extruder system 012 can degas and pump the polymer through a screen changer 019. A degassing system 015, which, for example can be a vacuum pump system in some embodiments, can draw the vapors/gas during the processing of both the DDC extruder system 010 via a line 014 and the compound extruder system 012 via a line 013. The compound extruder system 012 can comprise single-screw, twin-screw, and ring type extruders use in the wet wipe recycling process. By using a two-stage extruders layout concept that includes the DDC extruder system 010 and the compounding extruder 012 for the wet wipe recycling process, the molten polymer is processed in a manner that is conducive for recycled materials with high moisture content. Using both the DDC extruder system 010 and the compounding extruder 012 can allow the molten polymer to discharge into the atmosphere and permit remaining gas to escape from the molten polymer. Such a two-stage process line can also allow additives, colors, and booster resin to be fed into the molten polymer at the compound extruder system 012 once the wet wipe waste material has been already processed into a molten polymer state. In some embodiments, the principles of operation of the DDC extruder can be combined with the principles of operation of the compounding extruder into a single stage for the wet wipe recycling process to allow the wet wipe recycling apparatus to have reduced space and components as well and lower power consumption and maintenance costs.

The screen changer 019 can filter the molten polymer 011 to remove contamination particles from the polymer 011. The screen changer 019 can comprise slide plate, single bolts, dual bolts, rotary, belt, or a filter drum screen changer. The polymer 011 can then be discharged to a pelletizer system 020 that can include the pelletizer cutting chamber 024 cuts the molten polymer 011 into small pieces. The pelletizers can include, but are not limited to, underwater pelletizer, strand cut pelletizer, watering pelletizer, hot air, or hot face pelletizer, or the like. Process water from the water pump 021 flows through the heat exchanger 022 to condition the water temperature of the process water and is then pumped through the process water line 023 to collect the cut pellets at the cutting chamber 024. The process water solidifies the molten polymer 011 into a solid form (pellets form) during the cutting process. A slurry of processed water and pellets can then be pump through the line 025 from the cutting chamber 024 through the agglomerate catcher 026 to the centrifugal dryer 027. The agglomerate catcher 026 can prevent and remove any large particle size lumps from entering the centrifugal dryer 027 to prevent damage within the centrifugal dryer 027. The centrifugal dryer 027 can separate the pellets from the process water, and the process water can be discharged from a centrifugal dryer 027 to a water tank 028 so that the process water can be reused. A blower 029 can create a counter current airflow, allowing longer pellet resident time in the centrifugal dryer 027. Simultaneously, the blower 029 can pull off surface moisture from the pellets, and the pellets 030 can be then discharged from the centrifugal dryer 027.

Referring the FIG. 5B, another embodiment of a system for recycling wet wipes products, generally designated 108, is provided. The recycling system 108 is similar to the embodiment of the recycling system 104 but instead of a series of three shredders, the system 108 can comprise a single shredder 002. As compared to the shredders system shown in FIG. 5A, the single shredder 002 of the system 108 in FIG. 5B has more horsepower and a screen through which the processed material WP4 must pass through once the individual pieces of processed material small enough. The screen forces the waste wet wipe material into shredder rollers of the shredder 002 multiple times. Having a single shredder 002 can conserve space, but more horsepower is needed for the single shredder 002 to force the processed material WP4 through the screen.

Referring the FIG. 5C, another embodiment of a system for recycling wet wipes products, generally designated 110, is provided. The recycling system 110 is similar to the embodiment of the recycling system 104 except that the compound extruder system 012 in the recycling system 104 in FIG. 5A is not present in the recycling system 110. In the recycling system 110, feeders 016, 017, and 018 can feed additives, colors, and booster resin into the DCC extruder system 010 as needed or desired to achieve the end recycled product based on a formula requirement. Similarly, referring the FIG. 5D, another embodiment of a system for recycling wet wipes products, generally designated 112, is provided that is a cross between the recycling system 108 shown in FIG. 5B and the recycling system 110 shown in FIG. 5C. The system 112 can comprise a single shredder 002 and only employs a DDC extruder system 010 without a compound extruders system such that feeders 016, 017, and 018 can feed additives, colors, and booster resin into the DCC extruder system 010 if needed.

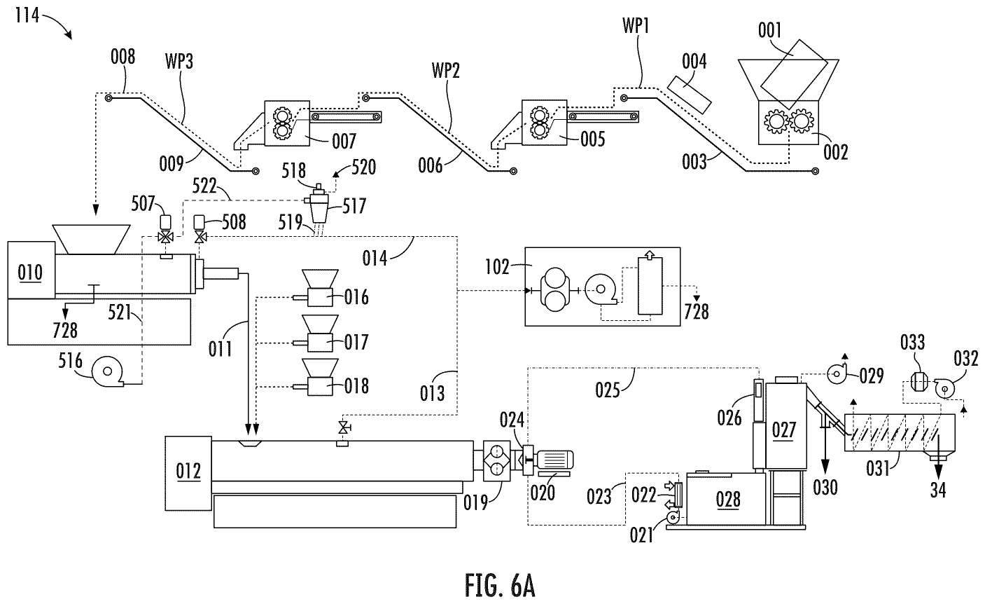

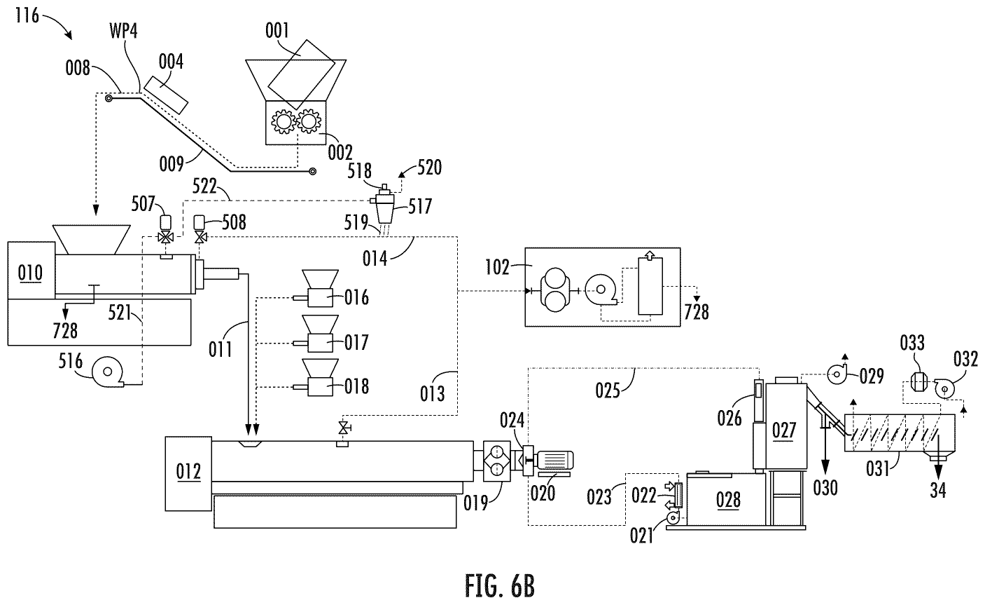

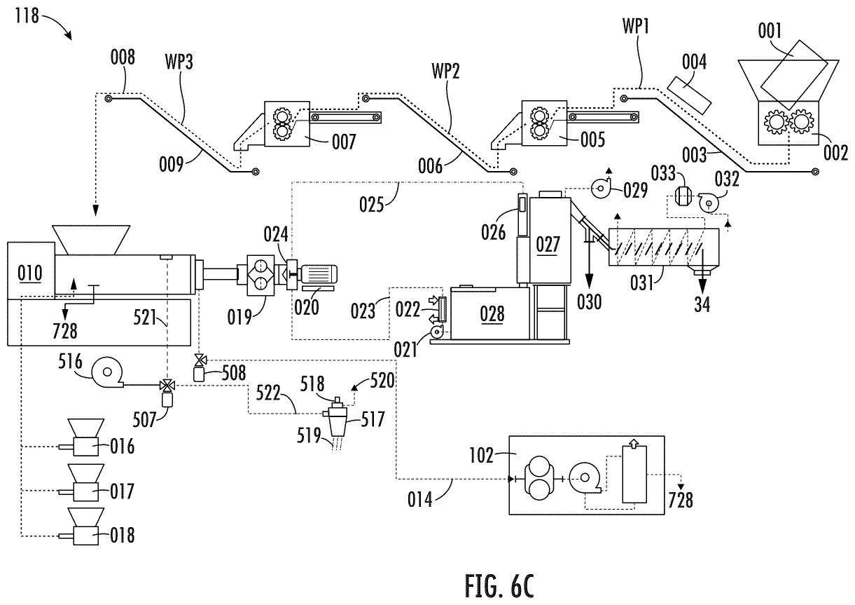

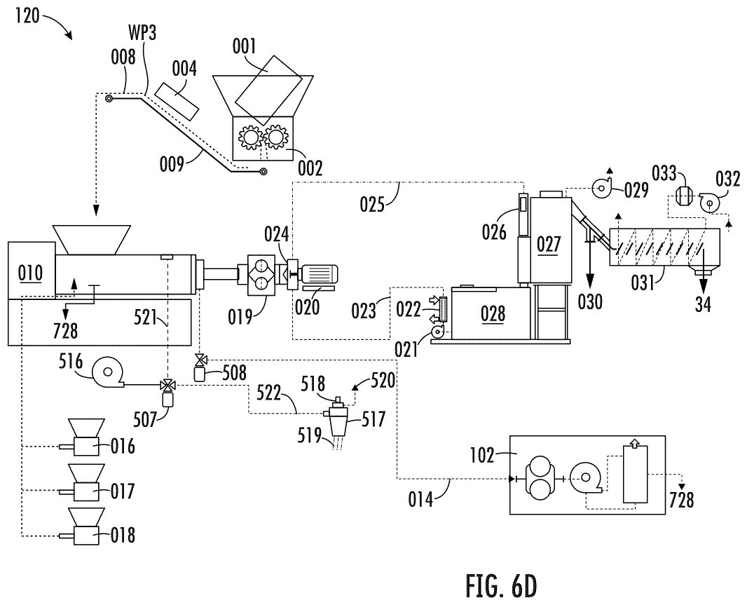

Referring to FIG. 6A-6D, embodiments are provided of wet wipe recycling systems 114, 116, 118, 120 that can be used to produce hard-shell lightweight plastic (HSLP) pellets in processes that are similar to the wet wipe recycling system for making the WWPC pellets shown in FIGS. 5A-5D. However, HSLP pellets have a porous structure while WWPC pellets are solid. In particular, at the pelletizing stage with the cutting chamber 024 and pelletizer system 020, the process water solidifies the molten polymer 011 on the outside into a hard pellet form. But due to the porous structure of HSLP pellets, the moisture is absorbed into the pellets during this stage. After the pellets pass through the centrifugal dryer 027 in the wet wipe recycling systems 114, 116, 118, 120, they enter a tumbler dryer 031 that is used as an extra pellet drying device to get pellet moisture content down. Pellets flow through the rotating screen drum in the tumbler dryer 031, and a blower 032 circulates heated air 033 through the pellets to further dry the pellets such that the final dried pellets have less moisture content when they are discharged from the tumbler dryer outlet 034. Other than the tumble dryer added to the systems, the recycling system 114 in FIG. 6A is similar in composition to the recycling system 104 in FIG. 5A. Similarly, the recycling system 116 in FIG. 6B is similar in composition to the recycling system 108 in FIG. 5B, and the recycling system 118 in FIG. 6C is similar in composition to the recycling system 110 in FIG. 5C. Additionally, the recycling system 120 in FIG. 6D is similar in composition to the recycling system 112 in FIG. 5D.

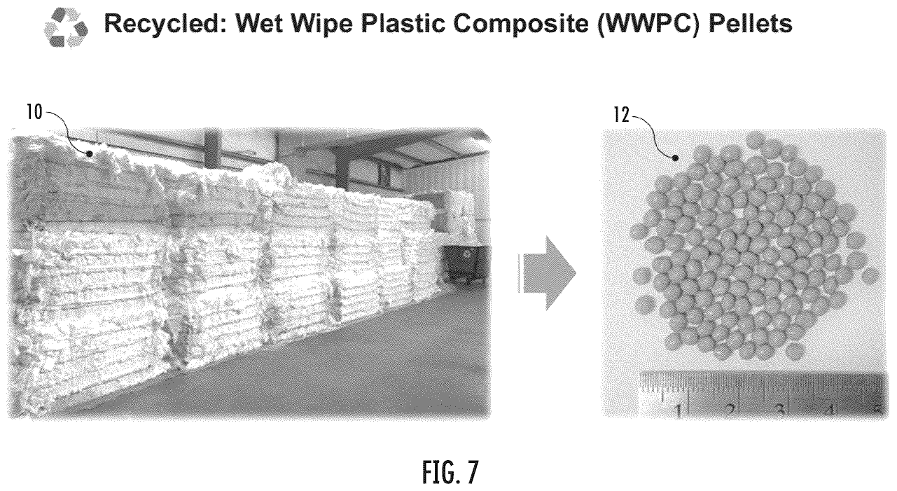

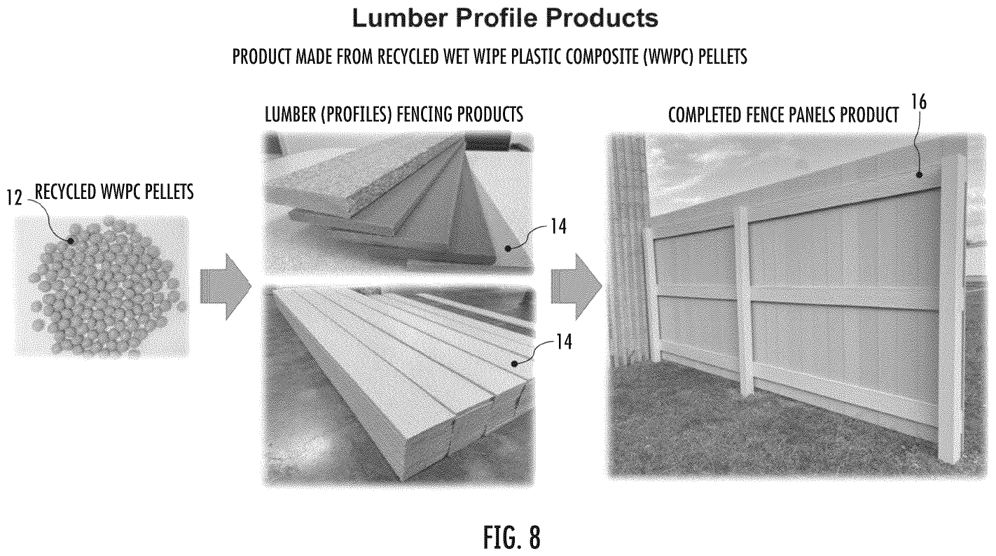

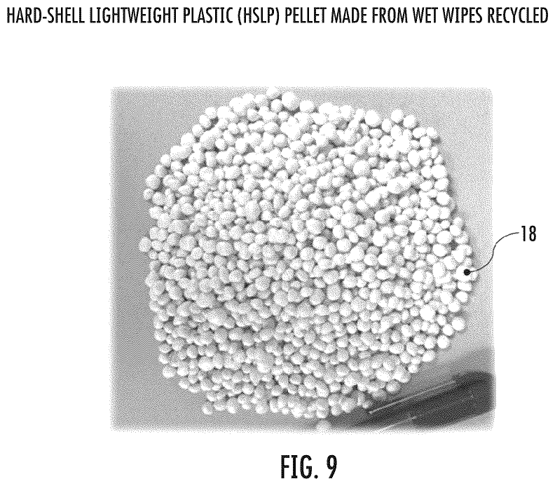

Thus, as described above, extruder systems, recycling systems, apparatuses, and related methods for recycling wet wipe waste material are disclosed herein. As described herein, post-industrial wet wipe and post-consumer wet wipe waste 10, which can be provided in bales to a recycler or in some other bulk can be recycled into wet wipe plastic composites (WWPC) in the form of pellets 12 in some embodiments shown in FIG. 7 or hard-shell lightweight plastic (HSLP) in the form of pellets 18 as shown in FIG. 9. The wet wipe plastic composites (WWPC) produced by the recycling apparatuses, system and methods discussed therein can be used as a substitute for wood plastic composites (WPC) profiles. For example, the profiles made from WWPC pellets 12 as shown in FIG. 8 can be used to form substitute lumber 14 as a substitute for wood lumber and other wood substitute components, including substitute lumber made from other polymer and wood composites. For instance, the WWPC pellets can be used to produce picket fence components 16 including the posts, pickets, rails, and caps of a picket fence. The WWPC can also be used to produce other posts, decking, trim & molding. Additionally, the WWPC can be used to produce furniture such as outdoor picnic tables and outdoor chairs. Basically, the WWPC can be used in producing any injection molding products that can include, but are not limited to pallets, garbage cans, automotive parts, electronic parts, or the like. The fibers from wet wipes fabric and non-woven fabric can be used to increase flexural modulus properties of plastic.

The extruder systems, recycling systems, apparatuses, and related methods for recycling wet wipe waste material described herein can be used to create hard-shell lightweight plastic (HSLP) pellet from wet wipe and other non-woven fabrics which can use the consistent layers of fiber and polymer in the fabric and the internal moisture contents in the fabric. For example, the internal moisture contents of fabric (H2O gas) can be used as a nucleating agent. The HSLP pellets can be used to form or create aggregate in concrete, bean bags, packaging, filtration application, or the like. The technique of using internal moisture contents of fabric, particularly, H₂O gas, as a nucleating agent can be applied to the extrusion profile process to create a lightweighter profile. Similarly, the recycling systems and processes disclosed herein can utilize the consistent layers of fiber and polymer in the wet wipe fabrics in forming the lightweight extrusion profile parts.

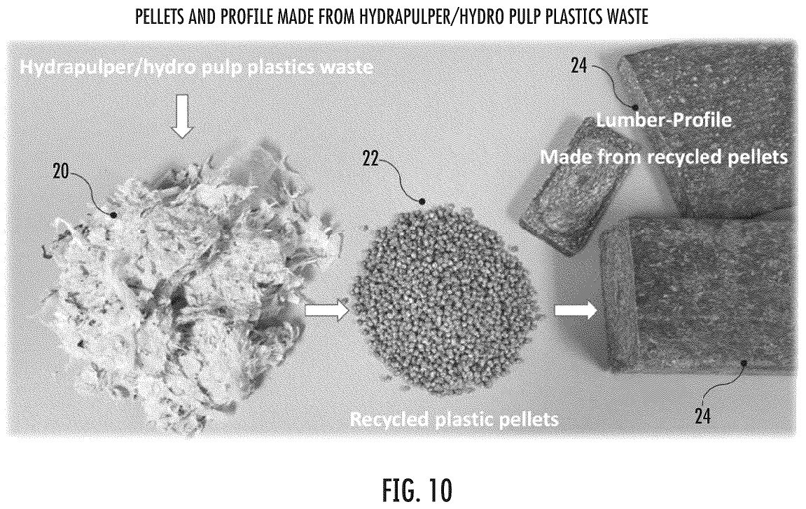

The extruder systems, recycling systems, apparatuses, and related methods for recycling wet wipe waste material described herein can be used to create recycled plastic pellets and lumber from hydrapulper/hydro pulp plastics waste material as shown in FIG. 10. Hydrapulper/hydro pulp waste material can comprise plastic-coated paper or laminated composite material that includes paper or paperboard with a plastic layer or treatment on the surface. This type of paper is commonly used in the food and drink packaging industry. Hydrapulper/hydro pulp waste material 20 has similar moisture content properties to wet wipe waste material. Hydrapulper/hydro pulp waste material 20 can contain moisture levels range from 20% to 80% or greater. Hydrapulper/hydro pulp plastics waste 20 can also contains waste paper material between 10% to 50%. Using the extruder systems, recycling systems, apparatuses, and related methods described above, the hydrapulper/hydro pulp waste material 20 can be converted to recycled plastic pellets 22 which can then be turned into other useful components when heated and extruder through desired forms, such as substitute lumber 24.

Thus, as disclosed above, the present disclosure also provides a recycling process for recycling wet waste material. The recycling process can comprise breaking down wet waste material being processed with one or more shredders and processing the broken-down wet waste material into a molten polymer using a dewatering, degassing, and compacting extruder. The recycling process can also comprise dewatering, degassing, and compacting the broken-down wet waste material and the molten polymer being processed in the dewatering, degassing, and compacting extruder and removing gas and waste material residue from the dewatering, degassing, and compacting extruder and capturing large residue particles.

The present disclosure also provides a recycling system for recycling wet wipe waste material. The recycling system can comprise a dewatering, degassing, and compacting extruder for receiving the broken-down wet wipe waste material. The dewatering, degassing, and compacting extruder can be configured to dewater, degas, and compact the wet wipe waste material received from the shredder to a molten polymer. The recycling system can also comprise a solid stage degassing port on the dewatering, degassing, and compacting extruder to remove gas or vapor released by molten polymer generated from the waste material being processed in the dewatering, degassing, and compacting extruder. In some embodiments, the recycling system can comprise one or more shredders for breaking down wet wipe waste material being processed for feeding the dewatering, degassing, and compacting extruder.

For example, as described above, the present disclosure provides for an extruder system for recycling wet waste products. The extruder system can comprise a main barrel comprising an inner chamber having a compressing and dewatering section and a heating, degassing, and compacting section following the compressing and dewatering section. An extruder screw can be provided. The extruder screw can comprise a dewatering, degassing and compression screw section and a discharge screw section. The dewatering, degassing and compression screw section of the extruder screw being configured to rotate within the inner chamber of the main barrel. The extruder system can also comprise a solid-stage degassing port positioned on the main barrel and engaging the inner chamber of the main barrel to remove gas or vapor released by molten polymer generated from the waste material being processed within the main barrel. Additionally, the extruder system can comprise a die positioned at the end of the main barrel and a predischarge flow channel for receiving the molten polymer exiting the die. The die can comprise one or more flow channels and can be configured to restrict a flow of material being processed in the main barrel to create backpressure and heat friction to help melt the waste material being processed into the molten polymer. The predischarge flow channel can be configured for heating and degassing the molten polymer. Further, the extruder system can comprise a discharge barrel connected to the predischarge flow channel. The discharge barrel can comprise an inner chamber in which the discharge screw section of the extruder screw can reside for receiving the molten polymer and a discharge port for discharging the molten polymer.

In some embodiments, the extruder system can comprise a molten-stage degassing port engaging the predischarge flow channel to remove the gas or vapor released by the molten polymer generated from the waste material being processed within the predischarge flow channel. In some embodiments, the extruder system can comprise a solid stage vent stuffer connected to the solid stage degassing port. The solid stage vent stuffer can have a vapor exhaust line extending therefrom and can be configured to prevent waste material being processed from entering the vapor exhaust line. In some embodiments, the extruder system can comprise a transfer blower connected to the vapor exhaust line of the solid stage vent stuffer. The transfer blower configured to provide air through the vapor exhaust line to convey vapors and material particles through the vapor exhaust line should any material particles pass through the solid stage vent stuffer. In some such embodiments, the extruder system can comprise a cyclone system connected to the vapor exhaust line. The cyclone system configured to separate the material particles from the vapors provided to the cyclone system by the vapor exhaust line. In some embodiments, the extruder system can comprise a molten stage vent stuffer connected to the molten stage degassing port. The molten stage vent stuffer can be connected to a vacuum line and can be configured to prevent the molten polymer within the predischarge flow channel entering the vacuum line and allow only gas or vapors to enter the vacuum line.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only and is not intended to limit the present subject matter.

1. An extruder system for recycling wet waste materials, the extruder system comprising:
a main barrel comprising an inner chamber having a compressing and dewatering section and a heating, degassing, and compacting section following the compressing and dewatering section;
an extruder screw comprising a dewatering, degassing and compression screw section and a discharge screw section, the dewatering, degassing and compression screw section of the extruder screw being configured to rotate within the inner chamber of the main barrel;
a solid stage degassing port positioned on the main barrel and engaging the inner chamber of the main barrel to remove gas or vapor released by a molten polymer generated from a waste material being processed within the main barrel;
a die positioned at an end of the main barrel, the die comprising one or more flow channels and configured to restrict a flow of material being processed in the main barrel and create backpressure and heat friction to help melt the material being processed into the molten polymer;
a predischarge flow channel for receiving the molten polymer exiting the die, the predischarge flow channel configured for heating and degassing the molten polymer; and
a discharge barrel connected to the predischarge flow channel, the discharge barrel comprising an inner chamber in which the discharge screw section of the extruder screw resides for receiving the molten polymer and a discharge port for discharging the molten polymer.

2. (canceled)

3. The extruder system according to claim 1, wherein the dewatering, degassing and compression screw section of the extruder screw comprises a main extruder screw and the discharge screw section comprises a discharge extruder screw.

4. The extruder system according to claim 3, wherein the main extruder screw comprises:
a shaft;
a first stage having a first section with a double start flight screw flight around the shaft having a long screw pitch and a deep screw flight channel and a second section having a tapered shaft surface without any screw flights; and
a second stage comprising a first section having a double start flight screw flight comprising a short screw pitch and shallow screw flight channel around a thicker section of the shaft, the screw flight of the second stage ending with kneader paddles.

5. The extruder system according to claim 4, wherein the discharge extruder screw is positioned within the inner chamber of the discharge barrel, the discharge extruder screw comprising a discharge screw shaft and a single start screw flight around the shaft having a short screw pitch and a shallow screw flight channel.

6. The extruder system according to claim 4, wherein, once the main extruder screw is installed in the inner chamber of the main barrel, the first stage of the main extruder screw aligns with the compressing and dewatering section of the main barrel and the second stage of the main extruder screw aligns with the heating, degassing, and compacting section of the main barrel; and
wherein the compressing and dewatering section of the main barrel comprises drain holes for draining liquid being extracted from the waste material being compressed by the main extruder screw.

7. (canceled)

8. The extruder system according to claim 3, wherein the main barrel comprises a breaker bar positioned along the inner chamber in the compressing and dewatering section and proximal to the main extruder screw.

9. The extruder system according to claim 6, wherein the heating, degassing, and compacting section of the main barrel comprises a heater for transferring heat from the main barrel to the waste material being processed.

10. The extruder system according to claim 1, further comprising a molten stage degassing port engaging the predischarge flow channel to remove the gas or vapor released by the molten polymer generated from the waste material being processed within the predischarge flow channel.

11. The extruder system according to claim 10, further comprising a solid stage vent stuffer connected to the solid stage degassing port, the solid stage vent stuffer having a vapor exhaust line extending therefrom and configured to prevent waste material being processed from entering the vapor exhaust line.

12. The extruder system according to claim 11, further comprising a transfer blower connected to the vapor exhaust line of the solid stage vent stuffer, the transfer blower configured to provide air through the vapor exhaust line to convey vapors and material particles through the vapor exhaust line should any material particles pass through the solid stage vent stuffer.

13. The extruder system according to claim 12, further comprising a cyclone system connected to the vapor exhaust line, the cyclone system configured to separate the material particles from the vapors provided to the cyclone system by the vapor exhaust line.

14. The extruder system according to claim 10, further comprising a molten stage vent stuffer connected to the molten stage degassing port, the molten stage vent stuffer connected to a vacuum line and configured to prevent the molten polymer within the predischarge flow channel entering the vacuum line and allow only gas or vapors to enter the vacuum line.

15. (canceled)

16. The extruder system according to claim 5, further comprising:
an end connector shaft that extends outward from the second stage of the extruder screw beyond an end of the main barrel;
a bearing and die housing connected to the end of the main barrel from which the end connector shaft of the main extruder screw extends in which the die is positioned;
a bearing positioned on the end connector shaft of the main extruder screw within the bearing and die housing, the bearing configured to integrate the end connector shaft of the main extruder screw to the bearing and die housing and to retain a rotating motion of the main extruder screw;
the bearing and die housing configured for heating polymer exiting the die and integration of the bearing and the die;
a discharge screw adapter engaging the bearing, the discharge screw adapter configured to couple the main extruder screw and the discharge extruder screw such that the discharge extruder screw rotates as the main extruder screw rotates; and
an adapter in which the predischarge flow channel resides downstream of the die, the adapter connected to the bearing and die housing.

17-18. (canceled)

19. The extruder system according to claim 4, further comprising:
a bearing and die housing connected to the end of the main barrel in which the die is positioned with the bearing and die housing comprising a chamber in which the die is secured and a section of the bearing and die housing on which one or more heaters are secured;
wherein the main extruder screw is configured to have kneader paddles at the end of the double start flight screw flight to mill and compress the waste material on the die proximate to the end of the main barrel.

20. The extruder system according to claim 1, wherein the one or more flow channels of the die comprise at least one of circular shaped holes or oval shaped holes to restrict the flow of material and, create backpressure and heat friction to help melt the waste material into a molten polymer.

21-22. (canceled)

23. The extruder system according to claim 19, wherein the bearing and die housing comprises multiple flow channels that allow molten polymer to flow from the die through to the predischarge flow channel.

24. The extruder system according to claim 16, wherein a molten stage degassing port extends through the adapter to allow gases or vapors to escape from the predischarge flow channel and one or more heaters are secured on a section of the adapter.

25. (canceled)

26. The extruder system according to claim 16, wherein the discharge barrel comprises first and second barrel elements secured together to form the discharge barrel with the first and second barrel elements such that heating and mixing of the molten polymer occurs within the discharge barrel as the discharge extruder screw rotates; and
one or more heaters are secured on the first and second barrel elements of the discharge barrel.

27. (canceled)

28. A recycling system for recycling wet wipe waste material, the recycling system comprising;
one or more shredders for breaking down wet waste material being processed;
a dewatering, degassing, and compacting extruder for receiving broken-down wet waste material from the one or more shredders, the dewatering, degassing, and compacting extruder configured to dewater, degas, and compact the wet waste material received from the one or more shredders to a molten polymer; and
at least one solid stage degassing port on the dewatering, degassing, and compacting extruder to remove gas or vapor released by molten polymer generated from the wet waste material being processed in the dewatering, degassing, and compacting extruder.

29. The recycling system according to claim 28, further comprising:
a die positioned at an end of the dewatering, degassing, and compacting extruder, the die comprising one or more flow channels and configured to restrict a flow of material being processed in a main barrel of the dewatering, degassing, and compacting extruder and create backpressure and heat friction to help melt the material being processed into a molten polymer; and
a predischarge flow channel for receiving the molten polymer exiting the die, the predischarge flow channel configured for heating and degassing the molten polymer.

30. The recycling system according to claim 29, further comprising at least one molten-stage degassing port engaging the predischarge flow channel to remove the gas or vapor released by the molten polymer generated from the wet waste material being processed within the predischarge flow channel.

31. The recycling system according to claim 28, further comprising a solid stage vent stuffer connected to each of the at least one solid stage degassing port, the solid stage vent stuffer having a vapor exhaust line extending therefrom and configured to prevent wet waste material being processed from entering the vapor exhaust line.

32. The recycling system according to claim 31, further comprising a transfer blower connected to the vapor exhaust line of the solid stage vent stuffer, the transfer blower configured to provide air through the vapor exhaust line to convey vapors and material particles through the vapor exhaust line should any material particles pass through the solid stage vent stuffer.

33-44. (canceled)

45. A recycling process for recycling wet waste material, the recycling process comprising;
breaking down wet waste material being processed with one or more shredders;
processing broken-down wet waste material into a molten polymer using a dewatering, degassing, and compacting extruder;
dewatering, degassing, and compacting the broken-down wet waste material and the molten polymer being processed in the dewatering, degassing, and compacting extruder; and
removing gas and residue from the dewatering, degassing, and compacting extruder and capturing large residue particles from the residue.

46. The recycling process according to claim 45, further comprising:
separating unwanted contamination within the molten polymer using at least one of a polymer filtration system or a screen changer;
cutting the molten polymer into pellets and solidifying the pellets in a liquid using a pelletizer;
removing the liquid and drying the pellets from a slurry of liquid and pellets using a centrifugal dryer; and
discharging the dried pellets from the centrifugal dryer.

47. The recycling process according to claim 45, further comprising further processing the molten polymer discharged from the dewatering, degassing, and compacting extruder in a compound extruder.

48. The recycling process according to claim 47, further comprising adding additives to the molten polymer being processed in the compound extruder.

49-63. (canceled)
